(19) United States
(12) Patent Application Publication
(10) Pub. No.: US 2010/0137479 A1
(43) Pub. Date: Jun. 3, 2010

(54) FLAME-RETARDANT POLYAMIDE COMPOSITIONS AND SHAPED ARTICLES MOLDED THEREFROM

(76) Inventors: Xavier Couillens, Tournefeuille (FR); Michelangelo Amorese, Milano (IT); Caroll Vergelati, Saint Baudille De LaTour (FR)

Correspondence Address: BUCHANAN, INGERSOLL & ROONEY PC, POST OFFICE BOX 1404, ALEXANDRIA, VA, 22313-1404, US

(21) Appl. No.: 12/514,208

(22) PCT Filed: Nov. 5, 2007
(86) PCT No.: PCT/EP2007/061881

§ 371 Date: Nov. 19, 2009

(30) Foreign Application Priority Data
Nov. 10, 2006 (FR) 0609827

(51) Int. Cl. C08K 5/3492

(52) U.S. Cl. 524/101

(57) ABSTRACT

Flame-retardant polyamide compositions that can be converted into molded shaped articles contain melamine cyanate and a novolac resin; such molded shaped articles are particularly useful in the field of electric or electronic connector technology, e.g., as circuit-breakers, switches or connectors.

The present invention relates to a flame-retardant polyamide composition that may be used especially for the manufacture of molded articles. The invention proposes a polyamide-based composition comprising melamine cyanurate and a novolac resin. The composition is especially useful for producing molded articles used in the field of electrical or electronic connections such as circuit breakers, switches and connectors.

The present invention relates to a flame-retardant polyamide composition that may be used especially for the manufacture of molded articles, particularly a polyamide composition that is flame retardant by means of a flame-retardant system free of halogen and phosphorus.

Polyamide resin-based compositions are used for producing articles via various forming processes denoted by the general term “molding”. These articles are used in many technical fields. Among these fields, the production of parts for electrical or electronic systems is an important application requiring particular properties. Thus, these parts must have high mechanical properties, but also properties of chemical resistance, electrical insulation and above all high fire resistance. These parts must furthermore maintain satisfactory dimensional stability after taking up moisture, to allow their functioning, and also preservation of their working properties in hot and humid countries.

Flame retardancy of polyamide resin-based compositions has been studied for a very long time. Thus, the main flame retardants used are red phosphorus and halogenated compounds such as dibromophenol, polybromodiphenols, polybromodiphenoxides and brominated polystyrenes. In the last twenty years, a new class of flame retardants has been found, namely organonitrogen compounds belonging to the triazine family, such as melamine or derivatives thereof, for instance melamine cyanurate and more recently melamine phosphates, polyphosphates and pyrophosphates.

The advantage of this latter class of flame retardants lies in the fact that the compounds concerned do not contain any halogens or phosphorus. Specifically, flame retardants containing halogens or red phosphorus may generate toxic gases or vapors during the combustion of the polyamide composition, or even during the production of said composition. However, the amounts of certain melamine-based compounds needed to obtain satisfactory flame retardancy are very high, especially for compositions containing reinforcing fillers in the form of fibers such as glass fibers, mineral fillers or heat-stable organic fibers. The cost of these compositions due to the large amounts of certain melamine-based compounds, especially melamine polyphosphates, makes their commercialization unattractive. Furthermore, this high concentration of melamine compounds presents certain drawbacks, especially during the manufacture of the composition, such as the production of vapor of the melamine compounds, or during the production of the molded articles, such as blockage of ventilation pipes and deposition in molds.

There is thus a need to prepare flame-retardant polyamide compositions based on melamine compounds that have a relatively low content of melamine compound.

Moreover, novolac resin is known to reduce the water uptake of polyamide compositions and thus to increase the dimensional stability of the resulting parts. However, a relatively large amount of novolac resin leads to a significant reduction of the mechanical properties. There is thus a need to prepare polyamide compositions which allow the manufacture of molded parts that have good dimensional stability with a relatively low content of novolac resin.

What is more, it appears that novolac resin leads to a reduction of the flame-retardancy properties of polyamide compositions comprising flame-retardant compounds. This is especially observed in the examples of the experimental section hereinbelow.

There is thus a need to prepare a flame-retardant polyamide composition that has low water uptake and that allows the production of parts with good dimensional stability, while at the same time avoiding the drawbacks mentioned previously.

The Applicant has now found, entirely surprisingly, that a polyamide composition comprising a low content of novolac resin and a relatively low content of melamine cyanurate, a melamine derivative, makes it possible to obtain optimal results in terms of flame retardancy and water uptake. Contrary to what was known hitherto, novolac resin does not impair the flame-retardancy properties of the polyamide composition comprising a melamine derivative.

The Applicant has furthermore found, entirely surprisingly, that in the polyamide composition the novolac resin and the melamine cyanurate act synergistically, whereas these two compounds usually act in different manners as flame retardants.

Specifically, novolac resin is known to be an agent that participates in the formation of a carbon layer (char) that isolates the polyamide matrix from the flame. In contrast, melamine cyanurate is known to act on the controlled breaking of the polyamide chains, causing the formation of drops of molten polyamide (dripping), which thus prevents propagation of the combustion.

The present invention thus relates to the use, in a polyamide matrix, of a combination of melamine cyanurate and of novolac resin as, or in relation with, a flame retardant.

One subject of the present invention is a polyamide-based composition comprising at least:
from 0.1% to 15% by weight of melamine cyanurate; and
from 0.1% to 5% by weight of novolac resin; relative to the total weight of the composition.

The polyamide is chosen from the group comprising the polyamides obtained by polycondensation of a linear dicarboxylic acid with a linear or cyclic diamine, such as PA 6.6, PA 6.10, PA 6.12, PA 12.12, PA 4.6 or MXD 6, or between an aromatic dicarboxylic acid and a linear or aromatic diamine, such as polyterephthalamides, polyisophthalamides, polyaramides, and polymers obtained by polycondensation of an amino acid with itself, the amino acid possibly being generated by hydrolytic opening of a lactam ring, for instance PA 6, PA 7, PA 11 and PA 12.

The composition of the invention may also comprise copolyamides derived especially from the above polyamides, or mixtures of these polyamides or copolyamides.

The preferred polyamides are polyhexamethylene adipamide, polycaprolactam or copolymers and mixtures between polyhexamethylene adipamide and polycaprolactam.

Use is generally made of polyamides whose molecular weights are suited to injection-molding processes, although polyamides of lower viscosity may also be used.

The polyamide matrix may especially be a polymer comprising star or H macromolecular chains and, where appropriate, linear macromolecular chains. Polymers comprising such star or H macromolecular chains are described, for example, in documents FR 2 743 077, FR 2 779 730, U.S. Pat. No. 5,959,069, EP 0 632 703, EP 0 682 057 and EP 0 832 149.

According to another particular variant of the invention, the polyamide matrix of the invention may be a polymer of statistical tree type, preferably a copolyamide having a statistical tree structure. These copolyamides of statistical tree structure and the process for obtaining them are especially described in document WO 99/03909. The matrix of the invention may also be a composition comprising a linear thermoplastic polymer and a star, H and/or tree thermoplastic polymer as described above. The matrix of the invention may also comprise a hyperbranched copolyamide of the type described in document WO 00/68298. The composition of the invention may also comprise any combination of linear, star, H or tree thermoplastic polymer and hyperbranched copolyamide as described above.

The composition according to the invention may comprise between 20% and 80% by weight and preferentially between 50% and 70% by weight of polyamide, relative to the total weight of the composition.

The composition according to the invention may also comprise a novolac resin. Novolac resins are polyhydroxy compounds, for example products of condensation of phenolic compounds with aldehydes. These condensation reactions are generally catalyzed with an acid.

The phenolic compounds may be chosen, alone or as a mixture, from phenol, cresol, xylenol, naphthol, and alkylphenols, for instance butylphenol, tert-butylphenol or isooctylphenol; or any other substituted phenol. The aldehyde most commonly used is formaldehyde. However, other aldehydes may be used, such as acetaldehyde, para-formaldehyde, butyraldehyde, crotonaldehyde and glyoxal.

The resins used advantageously have a higher molecular weight of between 500 and 3000 g/mol and preferably between 800 and 2000 g/mol.

Commercial novolac resins that may especially be mentioned include the commercial products Durez®, Vulkadur® and Rhenosin®.

The composition according to the invention may comprise between 0.1% and 5% by weight of novolac resin, especially from 1% to 4% by weight, particularly 1%, 2%, 3% or 4% by weight or proportions between these values, relative to the total weight of the composition.

The composition of the invention may comprise from 0.1% to 15% by weight and preferentially from 5% to 12% by weight of melamine cyanurate, relative to the total weight of the composition.

The composition may also comprise reinforcing fillers chosen especially from the group comprising glass fibers, and/or mineral fillers such as kaolin, talc or wollastonite, or alternatively exfoliable fillers. The weight concentration of the reinforcing fillers is advantageously between 1% and 50% by weight and preferably between 15% and 50% by weight relative to the total weight of the composition. A mixture of glass fibers and of mineral fillers, such as wollastonite, may especially be used.

The compositions of the invention may also comprise any additive usually used in polyamide-based compositions used for the manufacture of molded articles. Thus, examples of additives that may be mentioned include heat stabilizers, UV stabilizers, antioxidants, lubricants, pigments, colorants, plasticizers or impact strength modifiers. By way of example, the antioxidants and heat stabilizers are, for example, alkali metal halides, copper halides, sterically hindered phenolic compounds and aromatic amines. The UV stabilizers are generally benzotriazoles, benzophenones or HALS.

The compositions may moreover comprise in combination other compounds known for their flame-retardancy properties, for instance compounds based on red phosphorus, and alkaline-earth metal hydroxides such as magnesium hydroxide.

There is no limit to the types of impact strength modifier. It is generally elastomeric polymers that may be used for this purpose. Examples of suitable elastomers are ethylene-acrylic ester-maleic anhydride, ethylene-propylene-maleic anhydride, and EPDMs (ethylene-propylene-diene monomer) optionally with a grafted maleic anhydride. The weight concentration of elastomer is advantageously between 0.1% and 15% relative to the total weight of the composition.

The composition according to the invention is most preferentially constituted of:
20% to 80% by weight of polyamide resin, especially a polyamide 6.66, and copolymers or mixtures thereof;
0.1% to 15% by weight of melamine cyanurate;
0.1% to 5% by weight of novolac resin;
1% to 50% by weight of reinforcing fillers;
optionally additives chosen from the group comprising heat stabilizers, UV stabilizers, antioxidants, lubricants, pigments, colorants, plasticizers and impact strength modifiers; the weight percentages being expressed relative to the total weight of the composition.

The compositions of the invention are obtained by mixing the various constituents generally in a single-screw or twin-screw extruder, at a temperature sufficient to maintain the polyamide resin in molten medium. Generally, the mixture obtained is extruded in the form of rods that are chopped into pieces to form granules. The melamine cyanurate and the novolac resin may be added together or separately to the polyamide by hot or cold blending.

The addition of the compounds and additives may be performed by adding these compounds to the polyamide melt in pure form or in the form of a concentrated mixture in a resin, for instance a polyamide resin.

The granules obtained are used as starting material for feeding processes for manufacturing molded articles, such as injection-molding, extrusion or extrusion-blow molding processes.

Thus, the composition of the invention is particularly suitable for the manufacture of articles used in the field of electrical or electronic connections such as circuit breakers, switches, connectors or the like.

A specific language is used in the description so as to facilitate the understanding of the principle of the invention. However, it should be understood that no limitation of the scope of the invention is envisioned by the use of this specific language. Modifications, improvements and enhancements may especially be envisioned by a person skilled in the technical field concerned on the basis of his general knowledge.

The term “and/or” includes the meanings “and”, “or” and also any other possible combination of words connected to this term.

Other details or advantages of the invention will emerge more clearly in the light of the examples below, which are given purely as a guide.

### Experimental Section

Various compositions were manufactured by mixing polyamide with the various compounds. The mixing is performed in a twin-screw extruder at a temperature of 260° C. The mixture is extruded in the form of rods to form granules by chopping these rods.

The materials used are:
Polyamide: polyhexamethylene adipamide (PA 6.6) sold under the trade name Technyl A 27 A 00 sold by the company Rhodia
Melamine cyanurate: MC 25 sold by the company Ciba
Novolac resin: Rhenosin® PR 95 sold by the company Rhein Chemie
Wollastonite: 1015 sold by the company Nyco
Molding additives: talc, colorants, aluminum stearate
   Flame-retardant mixture F: aluminum diethyl phosphinate and melamine polyphosphate
Glass fibers: 99B (diameter of 10 μm) sold by the company Vetrotex.

The weight percentage concentration of each compound and the mechanical and flame-retardancy properties of each composition are indicated in the table below:

| Composition | C1 | 1 | C2 | C3 | C4 |
|---|---|---|---|---|---|
| Polyamide | 67 | 64 | 61 | 56 | 51.4 |
| Melamine cyanurate | 9 | 9 | 9 | 0 | 0 |
| Novolac resin | 0 | 3 | 8 | 0 | 4.6 |
| Wollastonite | 20 | 20 | 20 | 0 | 0 |
| Glass fibers | 0 | 0 | 0 | 25 | 25 |
| Molding additives | 4 | 4 | 4 | 4 | 4 |
| F | 0 | 0 | 0 | 15 | 15 |
| Properties | | | | | |
| Breaking energy | 43.9 | 35.0 | 33.7 | 59.7 | 57 |
| (KJ/m², ISO 179/1 eU) | | | | | |
| Tensile stress | 81 | 86 | 89 | 134 | 140 |
| (N/mm², ISO 527) | | | | | |
| Flammability | V2 | V2 | V2 | V0 | V2 |
| (UL 94 1/32″) | | | | | |
| Resistance to incan- | 960 | 960 | 850 | 960 | 850 |
| descent wire (IEC | | | | | |
| 60695-2-12 1.0 mm) | | | | | |
| Moisture uptake* (%) | 100 | −20.2 | −41 | 100 | — |

*the moisture uptake is measured by placing parts under particular conditioning composed of three repeating cycles: conditioning for 48 hours at 55° C. with a relative humidity of 95%, followed by conditioning for 24 hours at 23° C. with a relative humidity of 50%; and then compared with the moisture uptake of the reference sample C1 or C3 (100%).

It is thus observed that a polyamide composition comprising melamine cyanurate and a small content of novolac resin makes it possible to obtain a good compromise of mechanical and flame-retardancy properties and low moisture uptake.

1.-6. (canceled)

7. A flame-retardant polyamide composition comprising a matrix of at least one polyamide resin, from 0.1% to 15% by weight of melamine cyanurate and from 0.1% to 5% by weight of at least one novolac resin, each of the latter being relative to the total weight of the composition.

8. The flame-retardant polyamide composition as defined by claim 7, comprising from 1% to 4% by weight of at least one novolac resin, relative to the total weight of the composition.

9. The flame-retardant polyamide composition as defined by claim 7, comprising from 1% to 4% by weight of at least one novolac resin and from 5% to 12% by weight of melamine cyanurate, relative to the total weight of the composition.

10. The flame-retardant polyamide composition as defined by claim 7, comprising at least one reinforcing filler selected from the group consisting of glass fibers and mineral fillers.

11. The flame-retardant polyamide composition as defined by claim 7, comprising:
20% to 80% by weight of at least one polyamide resin;
0.1% to 15% by weight of melamine cyanurate;
0.1% to 5% by weight of at least one novolac resin;
1% to 50% by weight of at least one reinforcing filler; and
optionally, at least one additive selected from the group consisting of heat stabilizers, UV stabilizers, antioxidants, lubricants, pigments, colorants, plasticizers and impact strength modifiers; said weight percentages being expressed relative to the total weight of the composition.

12. An article produced by molding or shaping a flame-retardant polyamide composition as defined by claim 7.

13. A dimensionally stable molded shaped article comprising the flame-retardant polyamide composition as defined by claim 7.

14. Molding granules comprising the flame-retardant polyamide composition as defined by claim 7.
